(19) United States
(12) Patent Application Publication
(10) Pub. No.: US 2014/0205842 A1
(43) Pub. Date: Jul. 24, 2014

(54) ADVANCED SOLID SURFACE ACRYLIC AND METHOD

(71) Applicant: Aristech Acrylics LLC, Florence, KY (US)

(72) Inventors: Kevin Arthur Heitfeld, Cincinnati, OH (US); Mark Christopher Gatman, Erlanger, KY (US); Bryan J. Andrews, Union, KY (US)

(73) Assignee: Aristech Acrylics LLC, Florence, KY (US)

(21) Appl. No.: 14/140,770

(22) Filed: Dec. 26, 2013

Related U.S. Application Data
(60) Provisional application No. 61/747,102, filed on Dec. 28, 2012.

(51) Int. Cl. B32B 27/18; C08L 33/12

(52) U.S. Cl. CPC B32B 27/18; C08L 33/12
USPC 428/412; 156/308.2; 264/261; 524/437; 428/522; 428/519

(57) ABSTRACT

The present application describes compositions for making a cast, thermoformable sheet or slab, wherein the thermoformable sheet or slab demonstrates properties associated with both solid surface and polymeric materials. Additionally, the present application describes a method of welding the compositions described in the present application. Further, the present application describes a wall protection system utilizing the compositions described in the present application. Finally, the present application describes a method for laminating the compositions described in the present application onto a sheet or slab of a polymeric material.

### CROSS REFERENCE TO RELATED APPLICATION

This application claims the benefit of provisional patent application U.S. Ser. No. 61/747,102 filed Dec. 28, 2012, by the present inventor(s), which is incorporated by reference herein.

### TECHNICAL FIELD

The present application relates to thermoformable sheet or slabs of the type usable in or designed for architectural uses such as kitchen countertops, wall panels, vanity tops, bath/shower inserts, etc. The sheets or slabs contain significant amounts of flame retardant minerals, typically alumina trihydrate, and almost always have colorants in them, frequently in imitation of natural minerals such as onyx, marble or similar synthetic appearing solid color or patterned types. The present application describes a sheet or slab that can be heated and bent up to a 90° angle and/or that can be heated and vacuum formed into shapes like sinks and bowls without a significant esthetic sacrifice. In addition, the sheets or slabs of this disclosure display specific physical and other properties, like low flammability and minimal color changes after thermoforming; the uniform distribution of flame retardant significantly improves the consistency of impact resistance. Additionally, the present application describes a method for welding thermoformable sheets or slabs through the use of a hot gas welder and a miscible welding rod. Further, the present application describes a method for laminating thermoformable sheet or slabs together or onto polymeric sheets or slabs. Finally, the present application describes a wall protection system utilizing the thermoformable sheets or slabs and the welding methods of the present application.

### BACKGROUND

Sheets and slabs of synthetic mineral appearing material are now commonly used as kitchen countertops wall panels, vanity tops, bath/shower inserts, etc. and interior and exterior decorative coverings of all kinds for buildings such as banks, air terminals, stores, and the like. Such applications frequently require that the material be fabricated to fit custom designed areas, requiring in turn that the slabs or sheets be butted together or otherwise joined in ways that juxtapose a cross section with a normal surface at 90°.

The fabrication process requires extensive time and specially trained craftsmen to be completed successfully, since special tools and procedures are necessary. If a shaped, one piece part of continuous or monolithic material is desired, such a part can only be produced by casting it in a mold cavity under special conditions. In addition to the high costs of such a process and for the installation of the parts (fitting, gluing it in place to a flat sheet, and/or finishing, for example,) there are often color differences between the cast bowl, for example, and the flat slab of the same material.

The sheet (the terms “sheet” and “slab” will be used interchangeably herein) of the present application can provide a relatively complex finished part by a simple thermoforming operation—that is, the sheet is heated and then pulled by vacuum into a concave cavity (or convex) mold, where it is allowed to cool, to retain its new shape. Such a mold can be shaped as a vanity top, with one 90° back splash wall, with a front end bull nose of 1.0 inch radius and a vanity type bowl. After forming, cooling and trimming, the part can be installed directly in place, without additional fabrication required.

Only one contemporary commercial product (CORIAN® by DuPont) is said to be capable of being heat bent. However, its performance is not suitable, for example, to make 90° angle back splash wall, since the minimum radius of curvature specified by the CORIAN® literature is 3.0 inches.

In addition to meeting the above-described challenges, a material destined for use as a kitchen countertop wall panels, vanity tops, bath/shower inserts, etc, for example, should have a surface which is easily repairable and restored to its original appearance, such as by sanding and polishing, be protected against flammability, and have good temperature resistance in spite of being thermoformable.

The prior art has more or less neglected the goal of thermoformability or thermobending of solid surface sheets, since the prior art products were generally designed for reproducing the look of flat, natural, mineral based sheets.

### SUMMARY

A first aspect of the present application describes a composition for making a cast, thermoformable sheet or slab, comprising: a.) 25-100% of a syrup, comprising: 0-50% w/w or 35-99% w/w of prepolymerized monomer; 50-100% or 35-99% w/w of at least one monomer; 0-20% w/w of at least one crosslinking agent; and 0-5% w/w of at least one chain transfer agent; and b.) solid particulates, comprising: 0-70% w/w of aluminum trihydrate; and 0-5% w/w of at least one dispersant, wherein the thermoformable sheet or slab demonstrates properties associated with both solid surface and polymeric materials. In a preferred embodiment the syrup further comprises 0-5% w/w of at least one initiator. In a preferred embodiment the syrup further comprises 0-5% w/w of at least one release agent. In a preferred embodiment the syrup further comprises 0-5% of at least one anti-flocculating agent. In a preferred embodiment the solid particulates comprise 0-75% w/w of aluminum trihydrate.

A second preferred embodiment of the present application describes a method for welding a first thermoformable solid surface material comprising 0-70% aluminum trihydrate to a second material, comprising: a.) positioning the first and second materials adjacent to one another to form a gap between respective surfaces of the first and second materials; b.) inserting a welding rod into a welding tip of a hot gas welder; and c.) flowing the welding rod into the gap between the respective surfaces of the first and second materials through the welding tip on the hot gas welder. In a preferred embodiment the second material is selected from the group consisting of: the same as the first material and a polymeric material. In a preferred embodiment the welding rod is selected from the group consisting of: the same material as one or both of the first and second materials and a material having varying miscibility with both the first and second materials. In a preferred embodiment the varying miscibility material is selected from the group consisting of: polyvinylchloride; polycarbonate; and acrylonitrile butadiene styrene; polyacrylates; polystyrene copolymers; and blends of similar miscible polymers and adhesives. In a preferred embodiment the hot gas welder is operated at a temperature between 100° C. and 600° C. In a preferred embodiment each of the first and second surfaces consists of a broad side of a sheet. In a preferred embodiment each of the first and second surfaces consists of a narrow edge of a sheet.

A third preferred embodiment of the present application describes a wall protection system, comprising: a.) cast thermoformable sheets or slabs, comprising: i.) 25-100% of a syrup, comprising: 0-50% w/w or 35-99% w/w of prepolymerized monomer; 0-50% w/w or 35-99% w/w of at least one monomer; 0-20% w/w of at least one crosslinking agent; and 0-5% w/w of at least one chain transfer agent; and ii.) solid particulates, comprising: 0-75% w/w of aluminum trihydrate; and 0-5% w/w of at least one dispersant, wherein the cast, thermoformable sheets or slabs demonstrates properties associated with both solid surface and polymeric materials; b.) at least one welding rod; c.) a hot gas welder; and d.) means for adhering the cast, thermoformable sheets or slabs to a wall adjacent to one another to form a minimal gap between adjoining edges of the cast, thermoformable sheets or slabs. In a preferred embodiment the welding rod is selected from the group consisting of: the same material as the cast, thermoformable sheets or slabs; and a material having varying miscibility with the cast, thermoformable sheets or slabs. In a preferred embodiment the varying miscibility material is selected from the group consisting of: polyvinylchloride; polycarbonate; acrylonitrile butadiene styrene; polyacrylates; polystyrene copolymers; and blends of similar miscible polymers and adhesives. In a preferred embodiment the hot gas welder is operated at a temperature between 100° C. and 600° C. In a preferred embodiment the syrup further comprises 0-5% w/w of at least one initiator. In a preferred embodiment the syrup further comprises 0-5% w/w of at least one release agent. In a preferred embodiment the syrup further comprises 0-5% of at least one anti-flocculating agent.

A fourth preferred embodiment of the present application describes a method for laminating a cast, thermoformable sheet or slab onto a different polymeric sheet or slab, comprising: a.) positioning a cast, thermoformable sheet or slab flush on a surface of a polymeric sheet or slab, wherein the cast, thermoformable sheets or slabs are manufactured from a composition, comprising: i.) 25-100% of a syrup, comprising: 0-50% w/w or 35-99% w/w of prepolymerized monomer; 50-100% or 35-99% w/w of at least one monomer; 0-20% w/w of at least one crosslinking agent; and 0-5% w/w of at least one chain transfer agent; and ii.) solid particulates, comprising: 0-75% w/w of aluminum trihydrate; and 0-5% w/w of at least one dispersant, wherein the cast, thermoformable sheets or slabs demonstrates properties associated with both solid surface and polymeric materials; b.) heating the cast, thermoformable sheet or slab and the polymeric sheet or slab; and c.) applying pressure evenly across the surface of the cast thermoformable sheet or slab/polymeric sheet or slab laminate In a preferred embodiment the syrup further comprises 0-5% w/w of at least one initiator. In a preferred embodiment the syrup further comprises 0-5% w/w of at least one release agent. In a preferred embodiment the syrup further comprises 0-5% of at least one anti-flocculating agent. In a preferred embodiment the polymeric sheet or slab is selected from the group consisting of: polyvinylchloride; polycarbonate; polystyrene; polyethylene; polypropylene; polybutylene; polyisobutylene; acrylonitrile butadiene styrene; and thermoplastic polyolefins including these or similar polymers with or without the combination of a tie layer or tie layer adhesive.

### BRIEF DESCRIPTION OF THE DRAWINGS

FIG. 1: Illustrates cast thermoformable sheets of the present application containing 10% aluminum trihydrate by weight that have been welded using a.) a clear polyvinyl chloride welding rod; b.) a flexible polyvinyl chloride welding rod; and c.) an acrylonitrile butadiene styrene welding rod.

FIG. 2: Illustrates cast thermoformable sheets of the present application containing 30% aluminum trihydrate by weight that have been welded using a.) a clear polyvinyl chloride welding rod; b.) a flexible polyvinyl chloride welding rod; and c.) an acrylonitrile butadiene styrene welding rod.

FIG. 3: Illustrates a wall protection system of the present application.

### DETAILED DESCRIPTION

It is to be understood that the descriptions of the present disclosure have been simplified to illustrate elements that are relevant for a clear understanding of the present disclosure, while eliminating, for purposes of clarity, other elements that may be well known. Those of ordinary skill in the art will recognize that other elements are desirable and/or required in order to implement the present disclosure. However, because such elements are well known in the art, and because they do not facilitate a better understanding of the present disclosure, a discussion of such elements is not provided herein. Additionally, it is to be understood that the present disclosure is not limited to the embodiments described herein, but encompasses any and all embodiments within the scope of the description and the following claims

### DEFINITIONS

The following definitions apply to the terms as used throughout this specification, unless otherwise limited in specific instances.

As used herein, the term “polymer” is defined as a chemical compound or mixture of compounds consisting of repeating structural units created through a process of polymerization.

As used herein, the term “monomer” is defined as a molecule that may bind chemically to other molecules to form a polymer. Suitable monomers are, but are not limited to, ethylene, propylene, styrene, vinyl alcohol, vinyl acetate, vinyl chloride, acrylic acid, acrylonitrile, acrylonitrile, butadiene styrene, methacrylic acid, methyl methacrylate and tetrafluorethylene.

As used herein, the teen “acrylic” is defined as the polymer resulting from the polymerization of the methyl methacrylate (MMA) monomer to form polymethyl methacrylate (PMMA).

As used herein the term “PMMA” is polymethylmethacrylate having a (weight average) molecular weight range of about 30,000 to about 600,000 having no crosslinked polymer chains, in order to remain soluble in MMA. It is typically made in situ by partial polymerization of methyl methacrylate, but can be pre-polymerized and dissolved in the MMA.

As used herein the term “chain transfer agent” is defined as agents used to regulate the length of the polymer chains and thus to obtain the most suitable polymer matrix for thermoformability. Suitable chain transfer agents are, but are not limited to, octyl mercaptan, iso-dodecyl mercaptan, thiurams, dithiocarbarumates, dipentene dimercaptan, 2-mercapts ethanol, allyl mercapts-acetates, ethylene glycol dimercapts-acetate, trimethylolethane trithioglycolate and pentaerythritol tetrathioglycolate.

As used herein the term “initiator” is defined as agents introduced into a chemical mixture to begin a chain polymerization. Suitable initiators are, but are not limited to, t-butyl peroxypivalate, t-butyl peroxyneodeconate and t-amyl peroxy-2-ethyl-hexanoate.

As used herein the term “crosslinking agent” is defined as agents that form chemical bonds between two adjacent polymer chains. Suitable crosslinking agents are, but are not limited to, ethylene glycol dimethylacrylate, propylene dimethylacrylate, polyethylene-glycol dimethylacrylate, propylene dimethylacrylate, polyethylene-glycol dimethylacrylate, divinyl benzene, diallyl phthalate, 1,3-butanediolmethacrylate, 1,4-butane ethylene glycol dimethacrylate, neopentyl glycol dimethacrylate, trimethylol propane trimethacrylate, triallyl cyanurate, pentaerythritol tetramethacrylate, allylmethacrylate, hydroxyethylmethacrylate and hydroxypropylmethacrylate.

As used herein the term “hot gas welder” is defined as a specially designed heat gun that produces a jet of hot air that softens both the parts to be joined and a plastic filler rod, all of which must be of the same material or have varying miscibilities with one another. Suitable hot gas welders are, but are not limited to, those manufactured by Leister, Hapco and Kamweld. Additionally, for the scope of this application the term “hot gas welder” refers to extrusion welders wherein the welding rod is drawn into a miniature hand held plastic extruder, plasticized, and forced out of the extruder against the parts being joined, which are softened with a jet of hot air to allow bonding to take place. Suitable extrusion welders are, but are not limited to, those manufactured by Leister (Concord), Wegener, and Demtech.

As used herein the term “miscible” is defined as the ability of one liquid to mix with or dissolve in another liquid.

As used herein the term “tie layer”—film and/or adhesive that facilitates the bonding of two dissimilar materials.

As used herein the term “w/w” is defined as weight percent.

### DESCRIPTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. The following description is, therefore, not to be taken in a limited sense, and the scope of the inventive subject matter is defined by the appended claims and their equivalents.

Thus, in a first preferred embodiment, the present invention provides for a composition demonstrating properties associated with both solid surface materials (color retention, hardness, sandability, etc.) and polymeric materials (thermoformability, weldability, etc.) that can be cast or extruded into sheets or slabs is described herein.

A syrup that comprises 25-100% of the final composition weight is prepared by the addition of 0-50% w/w or 35-99% w/w of at least one pre-polymerized monomer, that contains between about 10% to about 30% solids is added to a solution containing 50-100% w/w or 35-99% w/w of at least one monomer. Suitable monomers are, but are not limited to, ethylene, propylene, styrene, vinyl alcohol, vinyl acetate, vinyl chloride, acrylic acid, acrylonitrile, acrylonitrile, butadiene styrene, methacrylic acid, methyl methacrylate and tetrafluorethylene. Preferred monomers are acrylic acid, methacrylic acid and methyl methacrylate, with methyl methacrylate being the most preferred monomer.

To the solution of at least one pre-polymerized monomer and at least one monomer is added 0-5% w/w of at least one crosslinking agent and Suitable crosslinking agents are, but are not limited to, ethylene glycol dimethylacrylate, propylene dimethylacrylate, polyethylene-glycol dimethylacrylate, propylene dimethylacrylate, polyethylene-glycol dimethylacrylate, divinyl benzene, diallyl phthalate, 1,3-butanediolmethacrylate, 1,4-butane ethylene glycol dimethacrylate, neopentyl glycol dimethacrylate, trimethylol propane trimethacrylate, triallyl cyanurate, pentaerythritol tetramethacrylate, allylmethacrylate, hydroxyethylmethacrylate and hydroxypropylmethacrylate. Preferred crosslinking agents are ethylene glycol dimethylacrylate, propylene dimethylacrylate, polyethylene-glycol dimethylacrylate, propylene dimethylacrylate, polyethylene-glycol dimethylacrylate, 1,3-butanediolmethacrylate, 1,4-butane ethylene glycol dimethacrylate, neopentyl glycol dimethacrylate, trimethylol propane trimethacrylate, pentaerythritol tetramethacrylate, allylmethacrylate, hydroxyethylmethacrylate and hydroxypropylmethacrylate with ethylene glycol dimethylacrylate being the most preferred.

Additionally, to the solution of at least one pre-polymerized monomer and at least one monomer is added 0-5% w/w of at least one chain transfer agent. Suitable chain transfer agents are, but are not limited to, octyl mercaptan, n-dodecyl mercaptan, iso-dodecyl mercaptan, thiurams, dithiocarbarumates, dipentene dimercaptan, 2-mercapts ethanol, allyl mercapts-acetates, ethylene glycol dimercapts-acetate, trimethylolethane trithioglycolate and pentaerythritol tetrathioglycolate. Preferred crosslinking agents are octyl mercaptan, n-dodecyl mercaptan, iso-dodecyl mercaptan, dipentene dimercaptan, 2-mercapts ethanol, allyl mercapts-acetates and ethylene glycol dimercapts-acetate with n-dodecyl mercaptan being the most preferred.

Additionally, to the solution of at least one prepolymerized monomer, at least one monomer, at least one crosslinking agent and at least one chain transfer agent may optionally be added 0-5% w/w of at least one initiator. Suitable initiators are, but are not limited to, t-butyl peroxypivalate, t-butyl peroxyneodeconate and t-amyl peroxy-2-ethyl-hexanoate.

Additionally, to the solution of at least one prepolymerized monomer, at least one monomer, at least one crosslinking agent and at least one chain transfer agent may optionally be added 0-5% w/w of at least one release agent. Suitable release agents are, but are not limited to, polyvinyl alcohol, wax, alkyl alcohols, glycerin, mineral oil, silicone. Preferred release agents are polyvinyl alcohol and alkyl alcohols, octan-1-ol and decan-1-ol being the most preferred.

Additionally, to the solution of at least one prepolymerized monomer, at least one monomer, at least one crosslinking agent and at least one chain transfer agent may optionally be added 0-5% w/w of at least one anti-flocculating agent. Suitable anti-flocculating agents are, but are not limited to, triisooctyl phosphate.

The solution of at least one prepolymerized monomer, at least one monomer, at least one crosslinking agent and at least one chain transfer agent, that optionally contains at least one initiator, optionally at least one release agent and optionally at least one anti-flocculating agent, is mixed with stirring to achieve a partially polymerized composition.

Optionally, the solution of at least one prepolymerized monomer, at least one monomer, at least one crosslinking agent and at least one chain transfer agent, that optionally contains at least one initiator, optionally at least one release agent and optionally at least one anti-flocculating agent may additionally contain one or more colorants, frequently in imitation of natural minerals such as onyx, marble or similar synthetic appearing solid color or patterned types.

To the syrup of at least one prepolymerized monomer, at least one monomer, at least one crosslinking agent and at least one chain transfer agent, that optionally contains at least one initiator, optionally at least one release agent and optionally at least one anti-flocculating agent, is added 0-75% w/w of aluminum trihydrate. Preferably, the aluminum trihydrate is present from about 1-50% w/w.

To the syrup of at least one prepolymerized monomer, at least one monomer, at least one crosslinking agent and at least one chain transfer agent, that optionally contains at least one initiator, optionally at least one release agent and optionally at least one anti-flocculating agent, is added 0-5% w/w of at least one dispersant. Suitable dispersants are, but are not limited to, ammonium lauryl sulfate, sodium lauryl sulfate, sodium laureth sulfate, sodium myreth sulfate, sodium stearate, sodium lauroyl sarcosinate, perfluorononanoate, perfluorooctanoate, octenidine dihydrochloride, cetyl trimethylammonium bromide, hexadecyl trimethyl ammonium bromide, cetyl trimethylammonium chloride, cetylpyridinium chloride, benzalkonium chloride, benzethonium chloride, 5-bromo-5-nitro-1,3-dioxane, dimethyldioctadecylammonium chloride, dioctadecyldimethylammonium bromide, cocamidopropyl hydroxysultaine, cocamidopropyl betaine, lecithin, cetyl alcohol, stearyl alcohol, and cetostearyl alcohol.

Optionally, to the syrup of at least one prepolymerized monomer, at least one monomer, at least one crosslinking agent and at least one chain transfer agent, that optionally contains at least one initiator, optionally at least one release agent and optionally at least one anti-flocculating agent, is added at least one additional flame retardant. Suitable flame retardants are, but are not limited to, Flame Check 1001, Flame Check 3150, Flame Check 1450A, zinc borate, polyphosphates, phosphites, melamine, metal hydrates, silicones and halogenated flame retardants.

The compositions of the present application have increased flame retardancy versus acrylic polymers (0% w/w aluminum trihydrate) and better weldability than solid surface materials. Therefore, cast sheets or slabs comprising compositions of the present application may be thermoformed into desired shapes and welded to other sheets or slabs to form a continuous surface.

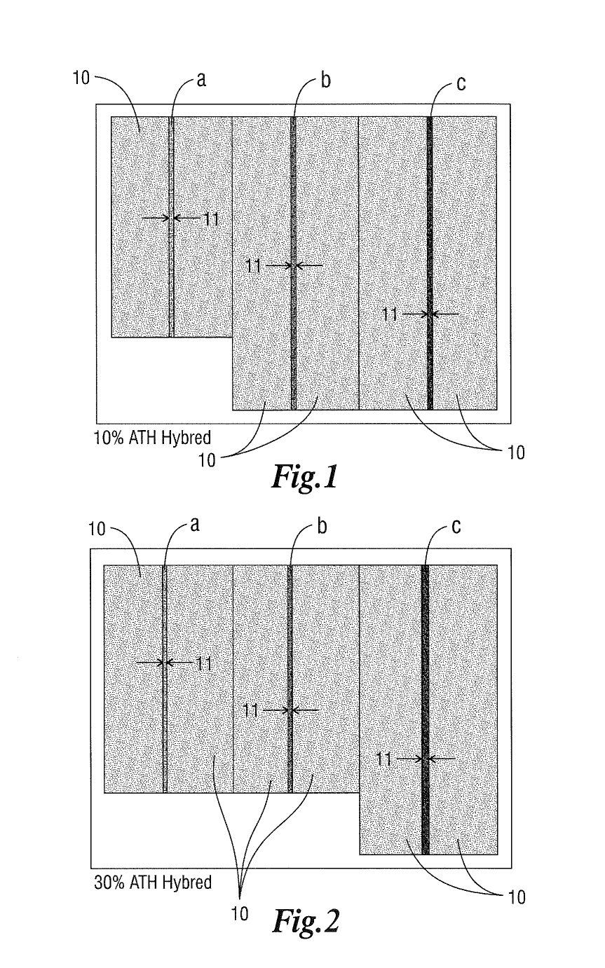

Thus, in a second embodiment, the present invention provides for a method of welding a composition demonstrating properties associated with both solid surface materials (color retention, hardness, sandability, etc.) and polymeric materials (thermoformability, weldability, etc.) that can be cast into sheets (10) or slabs (10), wherein the composition is described herein. FIGS. 1-2 illustrate the welding method of the present application that comprises positioning two or more sheets (10) or slabs (10) of the present application adjacent to one another to form a minimal gap (11) between the adjoining edges of the sheets (10) or slabs (10). Preferred gaps (11) between the sheets (10) or slabs (10) are between about 0-25 mm, with about 2 mm to about 6 mm being the most preferred. Using a hot gas welder, set at an appropriate operating temperature, with a welding tip and a welding rod to join two adjoining sheets or slabs by flowing the welding rod into the gap (11) between the adjoining sheets (10) or slabs (10). Suitable welding rods comprise either the compositions of the present application or a similar or miscible material. Preferred miscible materials are, but are not limited to, polyvinylchloride (a, b), polycarbonate, acrylonitrile butadiene styrene (c), polyacrylates, polystyrene copolymers; and blends of similar miscible polymers and adhesives. Preferred operating temperatures for the hot gas welder are between about 100-600° C.

Thus, in a third embodiment, the present invention provides for a wall protection system utilizing a composition demonstrating properties associated with both solid surface materials (color retention, hardness, sandability, etc.) and polymeric materials (thermoformability, weldability, etc.) that can be cast into sheets or slabs, wherein the composition is described herein.

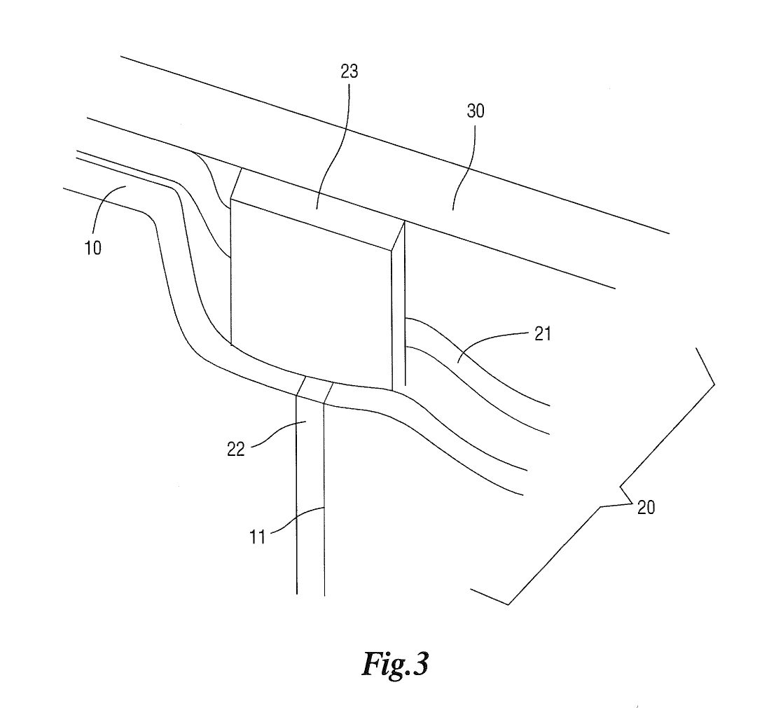

FIG. 3 illustrates the wall protection system (20) of the present application that comprises adhering two or more sheets (10) or slabs (10) of the present application adjacent to one another on a wall surface (30) by use of an adhesive (21) to form a minimal gap (11) between the adjoining edges of the sheets (10) or slabs (10). Preferred gaps (11) between the sheets (10) or slabs (10) are between about 0-25 mm, with about 2 mm to about 6 mm being the most preferred. Using a hot gas welder, set at an appropriate operating temperature, with a welding tip and a welding rod (22) to join two adjoining sheets (10) or slabs (10) by flowing the welding rod (22) into the gap between the adjoining sheets (10) or slabs (10). Suitable welding rods (22) comprise either the compositions of the present application or a miscible material. Preferred miscible materials are, but are not limited to, polyvinylchloride (a, b), polycarbonate, acrylonitrile butadiene styrene (c), polyacrylates, polystyrene copolymers, and blends of similar miscible polymers and adhesives. Preferred operating temperatures for the hot gas welder are between about 100-600° C. Optionally, a piece of double-sided tape (23) or a weldable polymer may be affixed to the wall surface (30) as a backer to the welding rod (22) as it fills the gap (11).

Thus, in a fourth embodiment, the present invention provides for a method of laminating a composition demonstrating properties associated with both solid surface materials (color retention, hardness, sandability, etc.) and polymeric materials (thermoformability, weldability, etc.) that can be cast into sheets or slabs, wherein the composition is described herein onto a different polymeric sheet or slab.

The lamination method of the present application comprises positioning a sheet or slab of the present application flush on a surface of a polymeric sheet or slab and subsequently applying heat and/or pressure sufficient to thermally bond the sheet or slab of the present application to the polymeric sheet or slab. Suitable polymeric sheets or slabs are, but are not limited to, polyvinylchloride, polycarbonate; acrylonitrile butadiene styrene, and thermoplastic polyolefins including these or similar polymers with or without the combination of a tie layer film or adhesive.

### EXAMPLES

The following working Examples serve to better illustrate, but not limit, some of the preferred embodiments of the invention.

### Example 1

Base syrup for preparing the compositions of the present application was prepared by adding a pre-polymerized mixture of methyl methacrylate containing about 20% solids (1,328 g) and a solution of methyl methacrylate (110.4 g) to a reaction vessel with stirring. To the stirring solution was added triisooctyl phosphate (8.5 g), pigment 6167 (42.5 g), n-dodecyl mercaptan (1.3 g), Zelec UN (0.21 g), ethylene glycol dimethacrylate (4.25 g), t-butyl peroxypivalate (1.85 g), t-butyl peroxyneodecanoate (2.74 g) and t-amyl peroxy-2-ethyl-hexanoate (0.28 g). This base syrup is used to prepare the compositions of the present application and is present in the final compositions from 25-100% w/w or 50-95% w/w.

### Example 2

A composition of the present application was prepared by adding base syrup from Example 1 (1,667 g) to a reaction vessel with stirring. Aluminum trihydrate (167 g) and BYK-1142 release agent (1.2 g) were added to the reaction mixture with stirring. The resulting reaction mixture was cast into a sheet and allowed to harden.

### Example 3

A composition of the present application was prepared by adding base syrup from Example 1 (800 g) to a reaction vessel with stirring. Aluminum trihydrate (228) was added to the reaction mixture with stirring. The resulting reaction mixture was cast into a sheet and allowed to harden.

### Example 4

A composition of the present application was prepared by adding base syrup from Example 1 (280 g) to a reaction vessel with stirring. Aluminum trihydrate (120 g) and Flame Check 1450A (20 g) were added to the reaction mixture with stirring. The resulting reaction mixture was cast into a sheet and allowed to harden.

### Example 5

A composition of the present application was prepared by adding base syrup from Example 1 (280 g) to a reaction vessel with stirring. Aluminum trihydrate (120 g) and Flame Check 1450A (8 g) were added to the reaction mixture with stirring. The resulting reaction mixture was cast into a sheet and allowed to harden.

### Example 6

A composition of the present application was prepared by adding base syrup from Example 1 (396 g) to a reaction vessel with stirring. Aluminum trihydrate (39.6 g) and Flame Check 1001 (4 g) were added to the reaction mixture with stirring. The resulting reaction mixture was cast into a sheet and allowed to harden.

### Example 7

A composition of the present application was prepared by adding base syrup from Example 1 (380 g) to a reaction vessel with stirring. Aluminum trihydrate (38 g) and Flame Check 1001 (20 g) were added to the reaction mixture with stirring. The resulting reaction mixture was cast into a sheet and allowed to harden.

### Example 8

A composition of the present application was prepared by adding base syrup from Example 1 (360 g) to a reaction vessel with stirring. Aluminum trihydrate (36 g) and Flame Check 1001 (40 g) were added to the reaction mixture with stirring. The resulting reaction mixture was cast into a sheet and allowed to harden.

### Example 9

A composition of the present application was prepared by adding base syrup from Example 1 (396 g) to a reaction vessel with stirring. Aluminum trihydrate (118.8 g) and Flame Check 3150 (4 g) were added to the reaction mixture with stirring. The resulting reaction mixture was cast into a sheet and allowed to harden.

### Example 10

A composition of the present application was prepared by adding base syrup from Example 1 (380 g) to a reaction vessel with stirring. Aluminum trihydrate (114 g) and Flame Check 3150 (20 g) were added to the reaction mixture with stirring. The resulting reaction mixture was cast into a sheet and allowed to harden.

### Example 11

A composition of the present application was prepared by adding base syrup from Example 1 (360 g) to a reaction vessel with stirring. Aluminum trihydrate (108 g) and Flame Check 3150 (40 g) were added to the reaction mixture with stirring. The resulting reaction mixture was cast into a sheet and allowed to harden.

### Example 12

A composition of the present application was prepared by adding base syrup from Example 1 (396 g) to a reaction vessel with stirring. Aluminum trihydrate (118.8 g) and Flame Check 1450A (4 g) were added to the reaction mixture with stirring. The resulting reaction mixture was cast into a sheet and allowed to harden.

### Example 13

A composition of the present application was prepared by adding base syrup from Example 1 (380 g) to a reaction vessel with stirring. Aluminum trihydrate (114 g) and Flame Check 1450A (20 g) were added to the reaction mixture with stirring. The resulting reaction mixture was cast into a sheet and allowed to harden.

### Example 14

A composition of the present application was prepared by adding base syrup from Example 1 (360 g) to a reaction vessel with stirring. Aluminum trihydrate (108 g) and Flame Check 1450A (40 g) were added to the reaction mixture with stirring. The resulting reaction mixture was cast into a sheet and allowed to harden.

### Example 15

A composition of the present application was prepared by adding base syrup from Example 1 (396 g) to a reaction vessel with stirring. Aluminum trihydrate (118.8 g) and zinc borate 467 (4 g) were added to the reaction mixture with stirring. The resulting reaction mixture was cast into a sheet and allowed to harden.

### Example 16

A composition of the present application was prepared by adding base syrup from Example 1 (380 g) to a reaction vessel with stirring. Aluminum trihydrate (114 g) and zinc borate 467 (20 g) were added to the reaction mixture with stirring. The resulting reaction mixture was cast into a sheet and allowed to harden.

### Example 17

A composition of the present application was prepared by adding base syrup from Example 1 (360 g) to a reaction vessel with stirring. Aluminum trihydrate (108 g) and zinc borate 467 (40 g) were added to the reaction mixture with stirring. The resulting reaction mixture was cast into a sheet and allowed to harden.

It should be understood that while this invention has been described herein in terms of specific embodiments set forth in detail, such embodiments are presented by way of illustration of the general principles of the invention, and the invention is not necessarily limited thereto. Certain modifications and variations in any given material, process step or chemical formula will be readily apparent to those skilled in the art without departing from the true spirit and scope of the present invention, and all such modifications and variations should be considered within the scope of the claims that follow.

What is claimed is:

1. A composition for making a cast, thermoformable sheet or slab, comprising:
a.) a syrup, comprising:
35-99% w/w of prepolymerized monomer;
35-99% w/w of at least one monomer;
0-20% w/w of at least one crosslinking agent; and
0-5% w/w of at least one chain transfer agent; and
b.) solid particulates, comprising:
0-70% w/w of aluminum trihydrate; and
0-5% w/w of at least one dispersant,
wherein the thermoformable sheet or slab demonstrates properties associated with both solid surface and polymeric materials.

2. The composition according to claim 1, wherein the syrup further comprises 0-5% w/w of at least one initiator.

3. The composition according to claim 1, wherein the syrup further comprises 0-5% w/w of at least one release agent.

4. The composition according to claim 1, wherein the syrup further comprises 0-5% of at least one anti-flocculating agent.

5. The composition according to claim 1, wherein the solid particulates comprise 5-15% w/w of aluminum trihydrate.

6. A method for welding a first thermoformable solid surface material comprising 0%-70% aluminum trihydrate to a second material, comprising:
a.) positioning the first and second materials adjacent to one another to form a gap between respective surfaces of the first and second materials;
b.) inserting a welding rod into a welding tip of a hot gas welder; and
c.) flowing the welding rod into the gap between the respective surfaces of the first and second materials through the welding tip on the hot gas welder.

7. The method according to claim 6, wherein the second material is selected from the group consisting of: the same as the first material and a polymeric material.

8. The method according to claim 6, wherein the welding rod is selected from the group consisting of: the same material as one or both of the first and second materials and a material having varying miscibility with both the first and second materials.

9. The method according to claim 6, wherein the varying miscibility material is selected from the group consisting of: polyvinylchloride; polycarbonate; and acrylonitrile butadiene styrene.

10. The method according to claim 6, wherein the hot gas welder is operated at a temperature between 100° C. and 600° C.

11. The method according to claim 6, wherein each of the first and second surfaces consist of a broad side of a sheet.

12. The method according to claim 6, wherein each of the first and second surfaces consist of a narrow edge of a sheet.

13. A wall protection system, comprising:
a.) cast thermoformable sheets or slabs, comprising:
i.) a syrup, comprising:
35-99% w/w of prepolymerized monomer;
35-99% w/w of at least one monomer;
0-20% w/w of at least one crosslinking agent; and
0-5% w/w of at least one chain transfer agent; and
ii.) solid particulates, comprising:
0-70% w/w of aluminum trihydrate; and
0-5% w/w of at least one dispersant,
wherein the cast, thermoformable sheets or slabs demonstrates properties associated with both solid surface and polymeric materials;
b.) at least one welding rod;
c.) a hot gas welder; and
d.) means for adhering the cast, thermoformable sheets or slabs to a wall adjacent to one another to form a minimal gap between adjoining edges of the cast, thermoformable sheets or slabs.

14. The system according to claim 13 wherein the welding rod is selected from the group consisting of: the same material as the cast, thermoformable sheets or slabs; and a material having varying miscibility with the cast, thermoformable sheets or slabs.

15. The system according to claim 14, wherein the varying miscibility material is selected from the group consisting of: polyvinylchloride; polycarbonate; and acrylonitrile butadiene styrene.

16. The system according to claim 13, wherein the hot gas welder is operated at a temperature between 100° C. and 600° C.

17. The system according to claim 13, wherein the syrup further comprises 0-5% w/w of at least one initiator.

18. A method for laminating a cast, thermoformable sheet or slab onto a different polymeric sheet or slab, comprising:
a.) positioning a cast, thermoformable sheet or slab flush on a surface of a polymeric sheet or slab, wherein the cast, thermoformable sheets or slabs are manufactured from a composition, comprising:
i.) a syrup, comprising:
35-99% w/w of prepolymerized monomer;
35-99% w/w of at least one monomer;
0-20% w/w of at least one crosslinking agent; and
0-5% w/w of at least one chain transfer agent; and
ii) solid particulates, comprising:
0-70% w/w of aluminum trihydrate; and
0-5% w/w of at least one dispersant,
wherein the cast, thermoformable sheets or slabs demonstrates properties associated with both solid surface and polymeric materials;
b.) heating the cast, thermoformable sheet or slab and the polymeric sheet or slab; and
c.) applying pressure evenly across the surface of the cast thermoformable sheet or slab/polymeric sheet or slab laminate.

19. The method according to claim 18, wherein the syrup further comprises 0-5% w/w of at least one initiator.

20. The method according to claim 18, wherein the syrup further comprises 0-5% w/w of at least one release agent.

21. The method according to claim 18, wherein the syrup further comprises 0-5% of at least one anti-flocculating agent.

22. The method according to claim 18, wherein the polymeric sheet or slab is selected from the group consisting of: polyvinylchloride; polycarbonate; polystyrene; polyethylene; polypropylene; polybutylene; polyisobutylene and acrylonitrile butadiene styrene.
